(19) United States
(12) Patent Application Publication
(10) Pub. No.: US 2026/0055809 A1
(43) Pub. Date: Feb. 26, 2026

(54) PLANET-CARRIER

(71) Applicant: AKTIEBOLAGET SKF, GOTEBORG (SE)

(72) Inventors: Ingo SCHULZ, Gerolzhofen (DE); Detlef LENHARD, Kolitzheim (DE); Daniel RECK, Würzburg (DE)

(21) Appl. No.: 19/110,967

(22) PCT Filed: Sep. 19, 2022
(86) PCT No.: PCT/EP2022/075919

§ 371 Date: Mar. 12, 2025

(51) Int. Cl. F16H 57/08

(52) U.S. Cl. CPC F16H 57/082

(57) ABSTRACT

A planet-carrier includes first and second cylindrical discs which are arranged coaxially with respect to a common axis of rotation and which face toward one another with their respective basal surfaces. The first and second discs have several axial outer bores and the outer bores extend parallel to the axis of rotation. The outer bores of the first and second discs are aligned with one another, and have been designed to accommodate planetary bearings for supporting the planetary gears or for supporting planetary axles. Further, spacing elements, which take the form of elements separate from the first and second discs and which are in contact with the first and second discs, are provided between the first and second discs. The spacing elements have been designed to maintain a defined spacing between the first and second discs.

### CROSS-REFERENCE

This application is the U.S. national stage of International Application No. PCT/EP2022/075919 filed on Sep. 19, 2022.

### BACKGROUND OF THE INVENTION

The present invention relates to gear trains, and more particularly to a planet-carrier for planetary gear trains.

Planet-carriers are used in planetary gear trains, particularly in precision gear trains, in order to support the planets in the planetary gear train. The planet-carriers may consist of two cylindrical discs, between which rigidity elements are arranged. The rigidity elements serve to provide a torsional and flexural rigidity of the planet-carrier. The rigidity elements constitute an integral part of one or both discs, also called cheeks or jaws. Furthermore, bores in which planetary bearings can be accommodated have been provided in the discs, in order to support the planets in the planet-carrier.

In the currently known planet-carriers, in which the rigidity elements are an integral part of one or both discs, elaborate and expensive production is required, since either the rigidity elements have to be cut out of a material of the planet-carrier, or of the discs of the planet-carrier, for instance by milling, or they have to be moulded onto the material of the discs, for instance by welding. Furthermore, the rigidity elements that are used customarily have an approximate triangular shape, making production by machine complex and expensive.

In order to ensure a precisely defined and correctly adjusted preloading by the planet-carrier within the planetary gear train, it is furthermore necessary that the rigidity elements have the correct length. This is achieved by grinding the outer surface of the rigidity elements together with the respective disc. However, this requires complex handling and processing of the parts of the planet-carrier, since bearing seats which have been provided, in particular, in the discs, or already integrated bearing raceways, must not be damaged during such a grinding process.

### SUMMARY OF THE INVENTION

The object of the present invention is therefore to provide a planet-carrier that is easy and economical to produce.

The planet-carrier comprises first and second cylindrical discs which are arranged coaxially with respect to a common axis of rotation. The discs are spaced from one another and arranged with their respective basal surfaces, or top surfaces or front sides, facing toward one another. The first and second discs each have several axial outer bores in their respective basal surface for supporting planetary gears, the outer bores extending parallel to the axis of rotation. The outer bores of the first and second discs are aligned with one another and have been designed to accommodate planetary bearings for supporting the planetary gears or for supporting planetary axles.

Outer rings of the planetary bearings can be inserted into the outer bores. Alternatively, the outer bores may take the form of outer rings for the planetary bearings. In this case, the outer bores serve directly as outer rings, without additional outer rings being required. The rolling elements of the planetary bearings are able to roll along the surface of the outer bores which serve as running surface, or the surface of the outer bores serves as opposing surface for a slide bearing. Similarly, the outer bores may serve as seats of planetary axles, on which the planets with their bearing arrangement then move.

In order now to connect the first and second cylindrical discs to one another and, at the same time, to keep them spaced, spacing elements, which take the form of elements separate from the first and second discs and which are in contact with the first and second discs, have been provided between the first and second discs. The spacing elements have been designed to maintain a defined spacing between the first and second discs. However, the spacing elements not only serve to maintain a defined spacing between the first and second discs but serve, in addition, as rigidity elements such as were also provided in the planet-carriers known hitherto. By virtue of such rigidity elements, a support of the two discs and, at the same time, a torsional and flexural rigidity of the planet-carrier are ensured.

By virtue of the configuration of the spacing elements as separate elements, it is consequently possible to produce the first and second discs, as well as the spacing elements, separately in each instance. This makes easy manufacture possible, since the elements, which are preferably geometrically simple shapes, namely the two discs and the spacing elements, can be manufactured separately from one another and can be connected to one another only subsequently. At the same time, the functionality of the spacing elements, which corresponds to those of the rigidity elements used hitherto, namely to impart a torsional and flexural rigidity to the planet-carrier, continues to be provided.

Since the spacing elements are manufactured separately from the discs, in the course of the manufacture of the spacing elements no bearing seats or integrated bearing raceways, which may have been provided in the discs, are impaired, as was the case with planet-carriers used hitherto.

According to one embodiment, the spacing elements have been detachably fastened to the first and second discs. This fastening can be effected, for instance, by means of adhesive or such like. Alternatively, the spacing elements may have been coupled with the first and second discs by means of fastening means. These fastening elements may be screws or bolts or such like, but they may also be any other type of clamping mechanism. The fastening elements may preferably have been passed through the spacing elements and through the discs, and in this way may connect them to one another. For this purpose, the spacing elements may, for instance, have an inner bore, the fastening means extending through the respective inner bore of the spacing elements and through corresponding axial bores in the basal surfaces of the first and second discs.

The bores in the two discs may be through-bores. Alternatively, the bores in one of the discs may be blind bores. Also, some of the bores of one disc may be through-bores, and some others may be blind bores, in which case two corresponding bores of the first and second discs are respectively a through-bore and a blind bore, in order to be able to pass a fastening element through a through-bore of one disc, through the corresponding spacing element into the blind bore of the other disc. Furthermore, the bores, or some of the bores, may have been provided with threads which are able to co-operate with corresponding threads of the fastening means.

By virtue of the fastening elements, it is possible to connect the two discs to one another and to the spacing elements. Furthermore, by virtue of the fastening elements a desired clamping force is exerted on the discs and on the spacing elements, and as a result a corresponding preloading of the planet-carrier is generated.

According to a further embodiment, the fastening means are subjected to tensile loading, and the spacing elements are subjected to compressive loading. By this means, a defined preloading state in the planet-carrier obtains, the preloading state counteracting operating loads.

As already explained, by virtue of the spacing elements, or rigidity elements, a torsion of the two discs relative to one another is reduced, and the stiffening of the planet-carrier is increased. In addition, by virtue of the coupling of the discs a preloading by the fastening means, for instance by screws, is obtained, in that the discs are braced together via the spacing elements.

The spacing elements may have a cylindrical shape. In particular, if the planet-carrier is being employed in a planetary gear train in which the crosspiece is bearing a lower torque, use may be made of such cylindrical spacing elements, since here there is a lower requirement as regards torsional rigidity.

Such a cylindrical shape has the advantage that the spacing elements can be manufactured easily, by being cut off from a rod or a hollow tube, for instance. In particular, this makes easy manufacture in large numbers possible. Instead of the spacing elements being cut off from a rod or a hollow tube, they can also be produced by extrusion or similar methods. In order to bring the spacing elements for use in the planet-carrier to the same length, several spacing elements can be clamped together into a machine and ground jointly to the same length.

The two discs each have a smooth, dimensionally stable surface, at least on the basal surfaces facing toward one another, preferably on both basal surfaces in each instance. If the spacing elements which have been manufactured to the same length are then arranged between the discs, a precisely defined and uniform spacing between the two discs can be provided.

In a further embodiment, the spacing elements may have a polygonal shape, for instance a triangular shape such as has also been provided in planet-carriers known hitherto. Such a polygonal shape, for example a triangular shape, has the advantage that more material may be present in the outer region, as a result of which the torsional and flexural rigidity of the planet-carrier is increased further. In contrast to planet-carriers known hitherto, however, the planet-carrier proposed herein has the advantage, even in the case of a polygonal shape of the spacing elements, that the discs and the spacing elements are separate elements and can be manufactured separately, and consequently simpler and more economical production is possible.

The spacing elements may have been produced from various materials, such as, for instance, metal (for example, steel, aluminium, etc.) or from synthetic material (for example, polymer) or from ceramic. The appropriate material may have been selected in a manner depending upon the application and the associated requirements. For instance, ceramic has the advantage that a high preloading is possible, since ceramic constitutes a very load-resistant material. In the case where use is made of synthetic material, in particular the weight of the planet-carrier can be reduced, for example in comparison with metal.

Furthermore, the manufacture of the planet-carrier from separate parts has the advantage that different materials can be used for the discs and for the spacing elements. The material of the spacing elements can accordingly be chosen separately from the material of the discs, and can be optimized in accordance with the requisite functionality. For a planet-carrier that is employed in a planetary gear train with a high torque, a material can be chosen that is able to withstand relatively high forces—such as steel, for instance—whereas for a planet-carrier that is employed in a planetary gear train in a hot environment, a material can be chosen that is able to withstand high temperatures well—such as ceramic, for instance.

The spacing elements themselves may also consist of different materials; for example, some of the spacing elements may consist of metal, and some of the spacing elements may consist of synthetic material.

According to a further embodiment, each disc has an outer circumferential surface and an inner circumferential surface, the inner circumferential surface defining a central inner bore, the outer bores being arranged between the inner and outer circumferential surfaces. For instance, a sun gear of the planetary gear train can be passed through such a central inner bore.

According to a further embodiment, the spacing elements are arranged between the outer bores, in particular as close as possible to or adjoining, or adjacent to, the outer circumferential surface. Such an arrangement has the advantage, in particular, that the planet-carrier is supported and stiffened by the spacing elements in its outer region—that is to say, on the basal surface in the direction of the outer circumferential surface.

The planet-carrier may have an arbitrary number of outer bores, for example an even number or an odd number. A spacing element is preferably always arranged between two outer bores, though other types of arrangement are also possible, for instance two spacing elements between, in each instance, two outer bores, or two external bores between, in each instance, one spacing element. Furthermore, the number of outer bores, and therefore the number of planets that are capable of being accommodated, as well as the number of spacing elements, are capable of being scaled arbitrarily.

According to a further embodiment, the planet-carrier has additional fastening elements which have been designed to couple the first and second discs with one another. The additional fastening elements extend through corresponding bores in the basal surfaces of the first and second discs. In particular, the additional fastening elements may have been arranged adjoining, or as close as possible to, the spacing elements. By virtue of such additional fastening elements, it is possible to improve the connection of the two discs to one another. Furthermore, such additional fastening elements may also have been arranged in a central region around the axis of rotation, in particular within the outer bores. In this way, an additional coupling of the two discs in their middle can be obtained, improving the coupling of the two discs with one another, and increasing the overall stability. In this connection, the additional fastening elements in the central region may actually have been arranged centrically. An eccentric arrangement, for example to compensate for an imbalance, is also possible.

Furthermore, it is possible to connect the additional fastening elements to spacing elements, and to provide at the respective positions not only the fastening elements but, additionally, also spacing elements through which fastening elements extend.

According to a further embodiment, the first and second discs are identical to one another. In this way, not only is the production of the spacing elements simplified, but so is the production of the discs, since only one type of disc has to be manufactured, and they can then be arranged in mirror-image manner relative to one another. Furthermore, the spacing elements may be identical to one another, as already explained above, as a result of which, here too, production is simplified. In particular, in this way the individual elements can be produced in large numbers. Furthermore, it is possible to combine various individual elements as required, particularly with respect to material, number of bores, for example outer bores, etc. In this way, the same spacing elements can be combined with various discs, in order to realize various types of planet-carrier.

Consequently, the planet-carrier described herein can be used for any type of planetary gear train in which planets are to be guided and supported in planetary bearings in a planet-carrier, or planet axles are to be passed through the planet-carrier or pressed into it. Such a planet-carrier can be used in a planetary gear train with a sun gear, in which case the discs have a central inner bore, but it can also be used in a planetary gear train without a sun gear, in which case such a central inner bore may be omitted. Furthermore, the number of outer bores, the number of spacing elements, the material being used, the length of the spacing elements, etc. can be adapted, depending upon the desired functionality.

Further advantages and advantageous embodiments are specified in the description, in the drawings and in the Claims. In particular, the combinations of features specified in the description and in the drawings are purely exemplary, so the features may also be present individually or combined differently.

### BRIEF DESCRIPTION OF THE SEVERAL VIEWS OF THE DRAWINGS

In the following, the invention will be described in more detail on the basis of embodiment examples represented in the drawings. The embodiment examples, and the combinations shown in the embodiment examples, are purely exemplary and are not intended to establish the scope of protection of the invention. This scope is defined solely by the attached claims.

FIG. 1 shows an exploded view of a planet-carrier according to one embodiment;

FIG. 2 shows a plan view of a disc of the planet-carrier shown in FIG. 1;

FIG. 3 shows a perspective view of a disc of the planet-carrier shown in FIG. 1 according to a further embodiment; and

FIGS. 4-6 show plan views, each of a disc of the planet-carrier shown in FIG. 1, according to further embodiments.

### DETAILED DESCRIPTION OF THE INVENTION

In the following, like elements or elements having like functional effects are labelled with the same reference symbols.

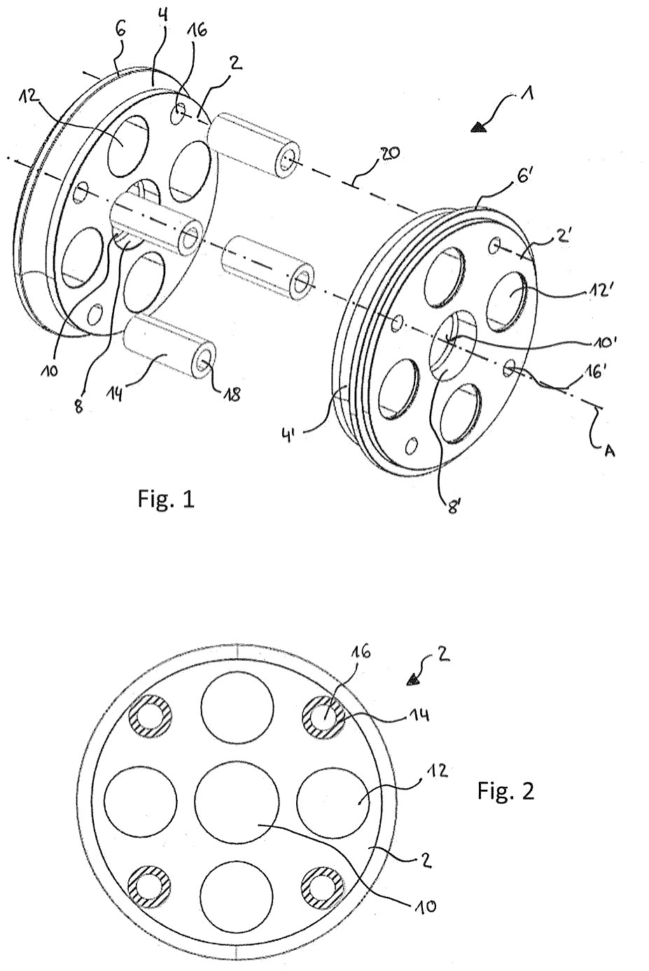

FIG. 1 shows a planet-carrier 1 which consists of two cylindrical discs 2, 2′. The first and second discs 2, 2′ have a common axis of rotation A and face toward one another with their basal surfaces, or top surfaces.

The two discs 2, 2′ are preferably identical, for which reason only one of the discs 2, 2′ will be described in detail in the following. A plan view of one of the discs 2 is shown in FIG. 2. The described features apply analogously to the two discs 2, 2′, the reference symbols of the first disc 2 being labelled with a “′” for the second disc 2′.

Disc 2 has an outer circumferential surface 4 which can be connected to, for instance, a housing via a main bearing (not shown). Alternatively, the planet-carrier 1 can also be employed without such a main bearing—that is to say, with a floating bearing arrangement. In the embodiment shown here, a flange 6 has been provided on the outer circumferential surface 4. The flange 6 can be used, on the one hand, for linking a drive, for example a further gear stage or an electric motor, or for linking an output, for example a further gear stage or a robot arm.

In the embodiments shown in FIGS. 1 to 5, disc 2 also has an inner circumferential surface 8 which defines a central inner bore 10. A sun gear (not shown) of a planetary gear train can be positioned in the inner bore 10.

In the embodiment shown in FIG. 1, outer bores 12 are arranged around the inner bore 10 on the basal surface of disc 2. In exemplary manner, four outer bores 12 are shown here, but more or fewer outer bores 12 may also have been provided. Planetary gears (not shown) can be accommodated in the outer bores 12. For this purpose, planetary bearings (not shown) which support the planetary gears in the planet-carrier 1 may have been arranged in the outer bores 12. In this case, outer rings of the planetary bearings may have been accommodated in the outer bores 12, or the outer bores 12 may themselves serve as outer rings. In this connection, it is to be noted that the two discs 2, 2′. or the outer bores 12, 12′ thereof, are aligned with one another. Moreover, the outer bores 12 can serve as seats of axles on which the planetary bearing arrangement and the planets have been mounted.

Spacing elements, or rigidity elements 14, have been provided between the two basal surfaces of the discs 2, 2′. These spacing elements 14 serve, on the one hand, to keep the two discs 2, 2′ spaced, and on the other hand they serve for stiffening the two discs 2, 2′, or the entire planet-carrier 1. The spacing elements 14 take the form of separate elements. By virtue of this design as separate elements, both the discs 2, 2′ and the spacing elements 14 can be produced in straightforward manner, since each element can be manufactured individually. For instance, the spacing elements 14, as represented in FIG. 1, may take the form of cylindrical hollow bodies which can be manufactured, for instance, by truncating a hollow tube. It should be noted, however, that the design as a hollow cylinder, as shown in FIG. 1, constitutes only one possibility, and the spacing elements 14 may also take the form of solid cylinders or some other form.

The spacing elements 14 may have been coupled with the two discs 2, 2′ via any type of clamping mechanism. For instance, the spacing elements 14 may have been connected to the two discs 2, 2′ via fastening elements (not shown) such as screws or bolts which extend through bores 16, 16′ in the two discs 2, 2′. As shown in FIG. 1 by the dashed line 20, bores 16, 16′ and bores 18 in the spacing elements 14 are aligned with one another, in order to make a fastening possible between the discs 2, 2′ and the spacing elements 14.

It should be noted that, even though four spacing elements and four outer bores 12, 12′ have been represented in FIG. 1, any other number of spacing elements 14 and bores 12, 12′ is possible. Furthermore, the inner bore 10 may also be dispensed with, and the planet-carrier 1 may be used in a planetary gear train without a sun gear.

The spacing elements 14 and the corresponding bores 16 in the basal surfaces of the discs 2, 2′ are preferably arranged in the marginal region of the basal surfaces. This has the advantage that the two discs 2, 2′ can be supported relative to one another by the spacing elements 14 in uniformly distributed manner via their basal surfaces. In this case, it is, in particular, preferred if the spacing elements 14 are each arranged between the outer bores 12.

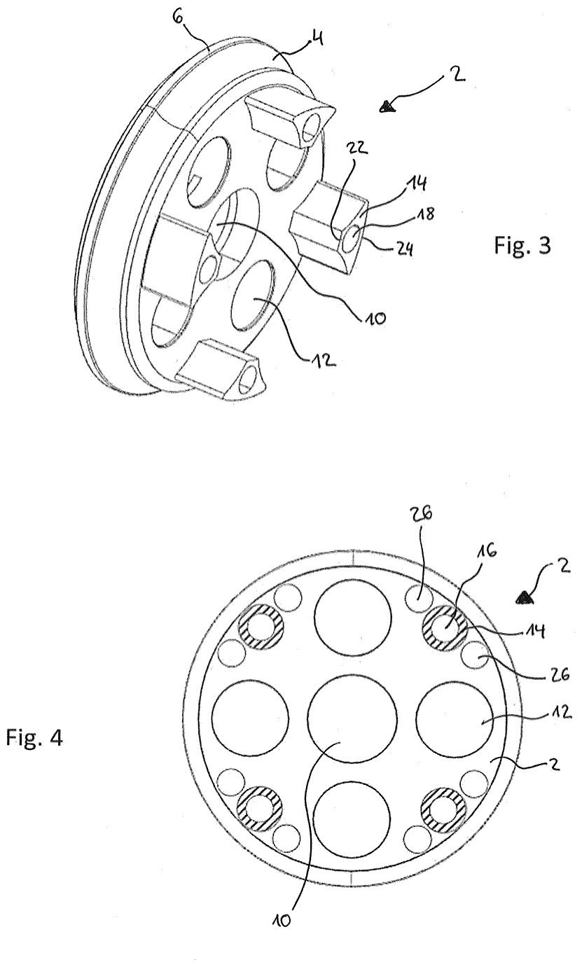

As already explained above, the spacing elements 14 may also have a shape other than the cylindrical shape represented in FIGS. 1, 2, 4 to 6. As shown in FIG. 3, the spacing elements 14 may, for instance, have a triangular shape. In this case, the spacing elements 14 are arranged with their broad side 24 in the direction of the outside and with their narrow side 22 in the direction of the inner bore 10. This has the advantage that more material is present in the outer region, in order to provide a better support and therefore a better torsional and flexural rigidity there. In FIG. 3, the spacing elements 14 are represented as having already been connected to disc 2, and the second disc 2′ (not shown) is likewise connected to the spacing elements 14.

In order to provide a better connection between the two discs 2, 2′, it is also possible to provide further fastening means in addition to the spacing elements 14 and the associated fastening means. As shown in FIG. 4, for example, additional fastening means can be passed through bores 26 which in FIG. 4 have been provided on both sides of the spacing elements 14. This improves the coupling of the two discs 2, 2′ and therefore results in a secure connection of the two discs 2, 2′.

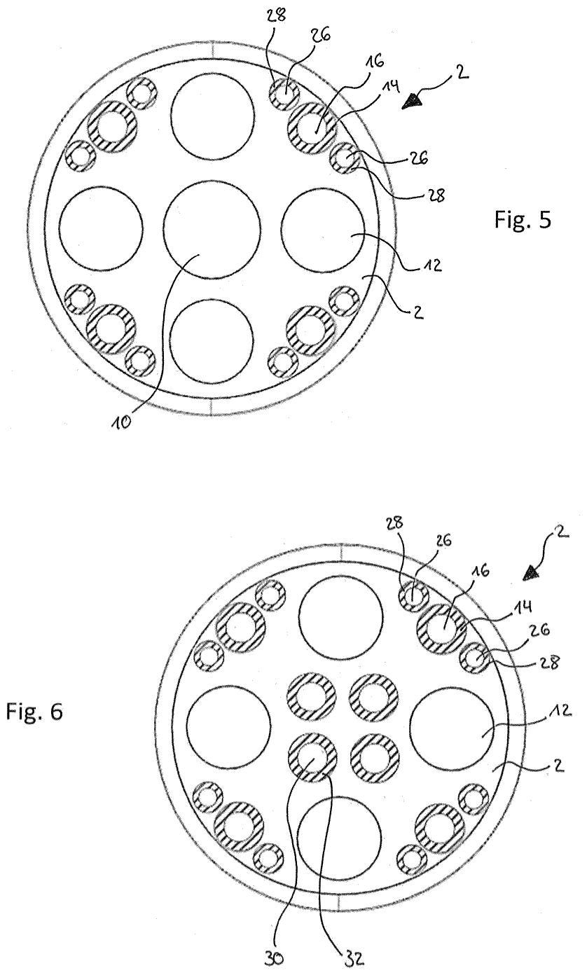

Instead of providing only additional fastening means via bores 26, further spacing elements 28 may also be present, as represented in FIG. 5. In this case, bores 26 are used not only for fastening means but additionally also for spacing elements 28, in which connection, as already described with respect to spacing elements 14 and bores 16, the fastening means extend through bores 26 in the two discs 2, 2′ and through spacing elements 28, or through a bore through spacing elements 28.

An increase in the torsional and flexural rigidity can also be obtained by further spacing elements being provided in the middle of the discs 2, 2′. As shown in FIG. 6, the planet-carrier 1 as a whole may also have been provided without an inner bore 10, in which case further spacing elements 32 may have been arranged in the middle around the axis of rotation A. As already described with respect to spacing elements 14 and 28, here too bores 30 have been provided in the discs 2, 2′, and spacing elements 32 are connected to the two discs 2, 2′ via fastening means through bores 30. Although no inner bore 10 is shown in FIG. 6, it is also possible to provide a smaller inner bore 10 and/or to arrange spacing elements 32 around the inner bore 10.

By virtue of the planet-carrier described herein, it is accordingly possible to enable easy and economical production of the individual parts of the planet-carrier, which nevertheless provide a sufficient torsional and flexural rigidity of the planet-carrier for use in planetary gear trains.

### LIST OF REFERENCE SYMBOLS

1 planet-carrier
2, 2′ disc
4, 4′ outer circumferential surface
6, 6′ flange
8, 8′ inner circumferential surface
10, 10′ inner bore
12, 12′ outer bore
14 spacing element
16, 16′ bore
18 through-bore
20 alignment line
22 narrow side
24 broad side
26 bores
28 spacing elements
30 bore
32 spacing element
A axis of rotation

1. A planet-carrier comprising:
first and second cylindrical discs arranged coaxially with respect to a common axis of rotation, each one of the first and second discs having a plurality of axial outer bores extending parallel to the axis of rotation and aligned with each other, each one of the outer bores being configured to accommodate planetary bearings for supporting the planetary gears or for supporting planetary axles; and
spacing elements separate from and provided between so as to be in contact with the first and second discs, the spacing elements being configured to maintain a defined spacing between the first and second discs;
wherein the spacing elements are coupled with the first and second discs by fastening means; and
wherein the spacing elements each have an inner bore and the fastening means respectively extend through the inner bores of the spacing elements and through corresponding axial bores in the first and second discs.

2. The planet-carrier according to claim 1, wherein the spacing elements are detachably fastened to the first and second discs.

3. The planet-carrier according to claim 2, wherein the fastening elements are subjected to tensile loading and the spacing elements are subjected to compressive loading so as to obtain a defined preloading state in the planet-carrier, the preloading state counteracting operating loads and operating stresses.

4. (canceled)

5. The planet-carrier according to claim 1, wherein the spacing elements have a cylindrical shape or a polygonal shape.

6. The planet-carrier according to claim 1, wherein the spacing elements are arranged adjacent to an outer circumferential surface of the first and second discs.

7. The planet-carrier according to claim 1, further comprising additional fastening elements configured to couple the first and second discs, wherein the additional fastening elements extend through corresponding bores in the first and second discs and are arranged adjacent to the spacing elements.

8. The planet-carrier according to claim 7, wherein the additional fastening elements are arranged in a central region around the axis of rotation.

9. The planet-carrier according to claim 1, wherein the spacing elements are formed from metal, synthetic material, and/or ceramic.

10. The planet-carrier according to claim 1, wherein the first and second discs are identical to one another and/or the spacing elements are identical to one another.
